(19) United States
(12) Patent Application Publication
(10) Pub. No.: US 2019/0210113 A1
(43) Pub. Date: Jul. 11, 2019

(54) HYBRID ADDITIVE MANUFACTURING

(71) Applicant: United Technologies Corporation, Farmington, CT (US)

(72) Inventors: Henry H. Thayer, Wethersfield, CT (US); Wendell V. Twelves, JR., Glastonbury, CT (US)

(21) Appl. No.: 15/864,771

(22) Filed: Jan. 8, 2018

(51) Int. Cl. B22F 7/04; B22F 3/105; B33Y 10/00; B33Y 30/00

(52) U.S. Cl. CPC B22F 7/04; B33Y 30/00; B33Y 10/00; B22F 3/1055

(57) ABSTRACT

An additive manufacturing system for fabricating a hybrid component includes a build platform having a platform surface at a first elevation and at least one preform structure secured proximate to the build platform. The preform structure includes a first preform surface located at a second elevation. The system further includes a powder deposition device disposed above the build platform at a third elevation, the third elevation being greater than the first and second elevations.

### BACKGROUND

Additive manufacturing is a useful process for forming three-dimensional components by creating successive layers of material. In metal additive manufacturing, metallic powder is spread along a build surface, and an energy source is used to rapidly and locally fuse the powder. The metal solidifies into successive layers that build up to form the desired part.

One of the drawbacks with current metal additive manufacturing processes is that certain geometries, such as downward-facing surfaces or internal passages, can be hard to control. Such geometries can have rough surfaces and/or other defects that can impede fluid flow and compromise the high-cycle fatigue properties of the component. Secondary processing is often required to finish/refine downward-facing, curved, and internal surfaces, which can lead to additional costs and longer time to produce.

### SUMMARY

An additive manufacturing system for fabricating a hybrid component includes a build platform having a platform surface at a first elevation and at least one preform structure secured proximate to the build platform. The preform structure includes a first preform surface located at a second elevation. The system further includes a powder deposition device disposed above the build platform at a third elevation, the third elevation being greater than the first and second elevations.

A method of fabricating a hybrid component includes the steps of securing a preform structure proximate to a build platform, depositing a first amount of metallic powder onto a platform surface located at a first elevation, and depositing a second amount of the metallic powder onto a preform surface located at a second elevation. The method further includes the step of energizing the first and second amounts of the metallic powder to form a fused layer.

### BRIEF DESCRIPTION OF THE DRAWINGS

FIGS. 1A and 1B are simplified illustrations of an additive manufacturing system.

FIGS. 2A and 2B are simplified illustrations of an alternative additive manufacturing system.

FIG. 3 illustrates the steps of forming a hybrid component using the disclosed additive manufacturing systems.

### DETAILED DESCRIPTION

The present invention is directed to a system and method of fabricating a hybrid component using additive manufacturing. During the build process, one or more preform structures are secured to a build platform, and successive layers of metallic powder are deposited over and/or around the preform by a powder deposition device positioned above the preform and build platform. The preform is designed to a desired specification, thus allowing for the fabrication of components with complex geometries and/or high-strength portions that would otherwise be difficult to form using a metal additive manufacturing process.

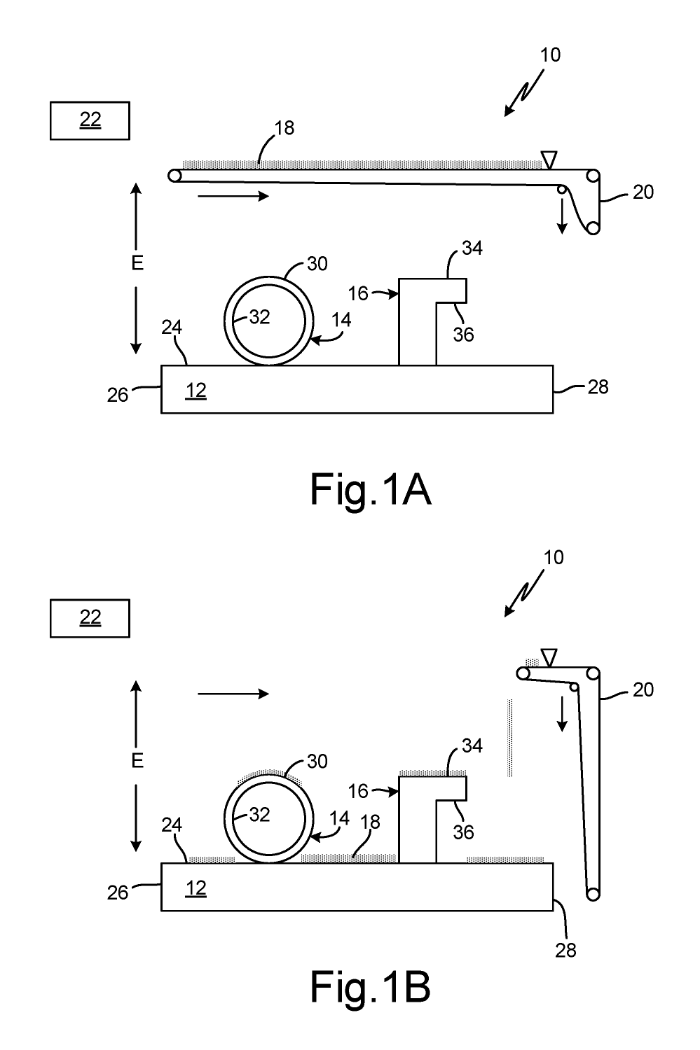

FIGS. 1A and 1B are simplified illustrations of additive manufacturing system 10. System 10 includes build platform 12, preforms 14 and 16, metallic powder 18, powder distribution device 20, and energy source 22. Build platform 12 can be a generally planar structure that includes platform surface 24, upon which a component can be formed. Build platform 12 further includes first end 26 and an opposing second end 28.

As is shown in FIGS. 1A and 1B, preform 14 is a hollow, cylindrical structure having an outer surface 30 and an inner surface 32. Preform 16 is a flanged structure having upper horizontal surface 34 and downward-facing surface 36. Surfaces 30 and 34, as shown, are higher than platform surface 24, and are generally capable of receiving metallic powder 18. Preforms 14 and 16 can be a metal or metal alloy formed using any traditional or additive manufacturing process known in the art as suitable for fabricating metal components. If necessary, preforms 14 and 16 can undergo secondary processing or finishing (e.g. milling, drilling, or polishing) to achieve desired features or surface finishes. For example, preform 14 can become a portion of a fluid passage, and thus it may be desirable for inner surface 32 to have a smooth finish. Preforms 14 and 16 can be secured to surface 24 of platform 12 using, for example, a welding or a brazing technique. Preforms 14 and 16 can alternatively be secured on or proximate to surface 24 using a fastening device, such as a clamp.

Powder distribution device 20 is located at an elevation E above build platform 12 and the uppermost surfaces of preforms 14 and 16, which in this case, are outer surfaces 30 and 34, respectively. In the embodiment shown, device 20 is a retractable conveyor belt configured to move over the build platform at elevation E, using a system of moving and fixed rollers. Specifically, device 20 can begin the position shown in FIG. 1A, and move from first end 26 to second end 28 distributing metallic powder 18 at predetermined locations on platform surface 24, and/or outer surfaces 30 and 34 of preforms 14 and 16. Metallic powder 18 will generally not be deposited onto inner surface 32 of preform 14, or downward-facing surface 36 of preform 16. When device 20 has reached the position shown in FIG. 1B, it can return to the position shown in FIG. 1A, or to some intermediate position (not shown), depending on the build parameters of the component being formed.

Metallic powder 18 can be a homogenous or heterogeneous metal or metal alloy powder, and can include materials like aluminum, nickel, titanium, cobalt, and chromium, to name a few, non-limiting examples. In some embodiments, metallic powder 18 and one or both of preforms 14 and 16 can be formed from the same material, while in other embodiments, powder 18 and one or both of preforms 14 and 16 can be formed from different materials. Factors influencing materials selection include the process used to fabricate the preforms, compatibility of the preforms and the metallic powder, and the desired mechanical properties of the hybrid component.

Energy source 22 can be used to energize and fuse deposited layers of metallic powder 18. Energy source 22 can be any directed energy source known in the art for use with metal additive manufacturing systems, such as a laser or electron beam. Energy source 22 can be fixed in place, or can be configured to move along build platform 12 in a manner similar to device 20. Device 20 and energy source 22 continue to operate together, depositing and fusing powder in a layer-by-layer fashion, until the hybrid component is formed.

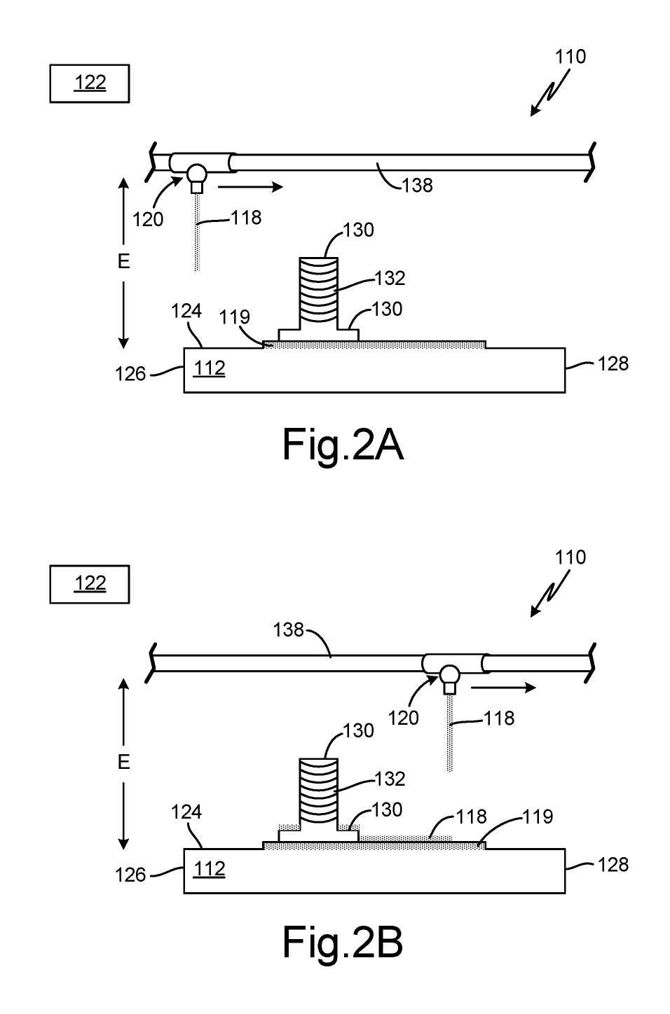

FIGS. 2A and 2B are simplified illustrations of alternative additive manufacturing system 110. System 110 includes build platform 112, preform 114, metallic powder 118, powder distribution device 120, and energy source 122. Build platform 112, metallic powder 118, and energy source 122 can be formed and/or operate in a manner substantially similar to build platform 12, metallic powder 18, and energy source 22 of system 10.

In the embodiment shown, preform 114 includes generally horizontal surfaces 130, each of which are relatively higher than platform surface 124, and are generally capable of receiving metallic powder 118. Preform 114 also includes threaded surface 132. Preform 114 can be formed in a manner substantially similar to preforms 14 and 16 of system 10. As can be seen in FIGS. 2A and 2B, preform 114 is secured to build platform 112 via a fused layer of metallic powder 119 disposed along platform surface 124 underneath preform 114. Such an arrangement can be desirable depending on how the preform is incorporated into the design of the hybrid component. In other embodiments, preform 114 can be in contact with only a portion of the fused layer, or it can be secured to build platform 112 in any manner discussed above with respect to preforms 14 and 16.

Powder distribution device 120 is configured as a biaxial gantry system, and like device 20, is located at an elevation E above build platform 112 and the uppermost surface of preform 114. In operation, device 120 moves along rail 138 between first end 126 and second end 128 of build platform 112, and deposits metallic powder 118 onto any of surface 124 and surfaces 130. Between each round of deposition, device 120 can further move in a direction orthogonal to its movement along rail 138, in order to deposit metallic powder 118 along the necessary area of build platform 112. Device 120 continues to deposit layers of metallic powder 118, and energy source 122 fuses the layers until the hybrid component is complete. A hybrid component formed with preform 114 can be, for example, a bracket requiring one or more threaded structures.

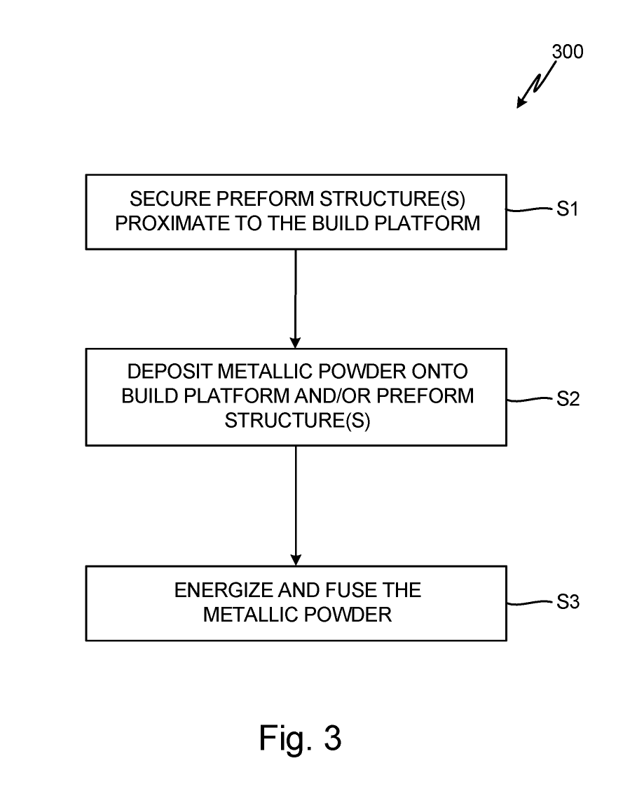

FIG. 3 illustrates method 300 for fabricating a hybrid component using systems 10 and 110. At step S1, one or more preforms are secured proximate to the build platform. At step S2, the powder deposition device deposits metallic powder on the build platform surface and/or the preform surface as it moves from one end of the build platform to another. At step S3, The deposited powder is energized by the directed energy source to form a fused layer. Steps S2 and S3 can be repeated, as necessary, until the desired component is formed.

Systems 10 and 110 can include additional and/or alternative features beyond those described above. It is further envisioned that many of the features of systems 10 and 110 can be interchangeable. For example, systems 10 and 110 can include one or more preforms, and the preforms can be uniform in design or vary. Preforms can include additional shapes and geometries, such as fins, apertures, conical, pyramidal, to name a few, non-limiting examples, and can be variably secured to either or both the platform surface and fused metallic powder, or secured above the platform surface in free space. Powder distribution devices 20 and 120 can also be used with either system. Alternative distribution devices, such as a multiaxial robotic arm, are also contemplated. Such a device can be used when more precise deposition of metallic powder at various elevations is desired, as well as deposition along non-horizontal surfaces. The disclosed systems can alternatively use a fluidized bed powder distribution device to deposit metallic powder onto the build plate and/or preforms. Platforms 12 and 112 can be formed as generally planar structures, or can be formed with contours or other surface features to facilitate the securing of the preforms, or to correspond to a desired shape of an additively manufactured portion of the hybrid component.

Systems 10 and 110 can be used to form any number of hybrid components for use in aerospace, such as turbine engine cooling system components, flow control manifolds, fluid/resin distribution manifolds, heat exchangers, airfoils, and more. The disclosed systems and method are further applicable to automotive, maritime, and other transportation industries, as well as industrial and power generation systems.

### DISCUSSION OF POSSIBLE EMBODIMENTS

The following are non-exclusive descriptions of possible embodiments of the present invention.

An additive manufacturing system for fabricating a hybrid component includes a build platform having a platform surface at a first elevation and at least one preform structure secured proximate to the build platform. The preform structure includes a first preform surface located at a second elevation. The system further includes a powder deposition device disposed above the build platform at a third elevation, the third elevation being greater than the first and second elevations.

The system of the preceding paragraph can optionally include, additionally and/or alternatively, any one or more of the following features, configurations and/or additional components:

In the above system, the second elevation can be greater than the first elevation.

In any of the above systems, the powder deposition device can be configured to deposit a metallic powder onto the platform surface and the first preform surface.

Any of the above systems can further include a directed energy source configured to energize and fuse the metallic powder.

In any of the above systems, the metallic powder can include a metal or metal alloy selected from the group consisting of aluminum, nickel, titanium, cobalt, chromium, and combinations thereof.

In any of the above systems, the preform structure can be formed from the same material as the metallic powder.

In any of the above systems, the powder distribution device can include a retractable conveyor belt.

In any of the above systems, the powder distribution device can include a biaxial gantry system.

In any of the above systems, the at least one preform structure can include a second preform surface.

In any of the above systems, the second preform surface can be a downward-facing surface, and internal surface, a threaded surface, and combinations thereof.

In any of the above systems, the at least one preform structure can include a first preform structure and a second preform structure.

A method of fabricating a hybrid component includes the steps of securing a preform structure proximate to a build platform, depositing a first amount of metallic powder onto a platform surface located at a first elevation, and depositing a second amount of the metallic powder onto a preform surface located at a second elevation. The method further includes the step of energizing the first and second amounts of the metallic powder to form a fused layer.

The method of the preceding paragraph can optionally include, additionally and/or alternatively, any one or more of the following features, configurations and/or additional components:

The above method can further include repeating the depositing and energizing steps to form the hybrid component, the hybrid component including the preform structure and a plurality of fused layers.

In any of the above methods, the second elevation can be greater than the first elevation.

In any of the above methods, the first and second amounts of the metallic powder can be deposited using a powder deposition device disposed above the build platform at a third elevation.

In any of the above methods, the powder deposition device can include a retractable conveyor belt or a biaxial gantry system.

In any of the above methods, the step of securing the preform structure can include brazing or welding the preform structure to a surface of the build platform.

In any of the above methods, the step of securing the preform structure can include brazing or welding the preform structure to a fused layer of the metallic powder.

In any of the above methods, the step of energizing the metallic powder can be performed by a directed energy source, such as a laser or an electron beam.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An additive manufacturing system for fabricating a hybrid component, the system comprising:
a build platform comprising a platform surface located at a first elevation;
at least one preform structure secured proximate to the build platform, the preform structure comprising a first preform surface located at a second elevation; and
a powder deposition device disposed above the build platform at a third elevation;
wherein the third elevation is greater than the first and second elevations.

2. The system of claim 1, wherein the second elevation is greater than the first elevation.

3. The system of claim 1, wherein the powder deposition device is configured to deposit a metallic powder onto the platform surface and the first preform surface.

4. The system of claim 3 and further comprising: a directed energy source configured to energize and fuse the metallic powder.

5. The system of claim 3, wherein the metallic powder comprises a metal or metal alloy selected from the group consisting of aluminum, nickel, titanium, cobalt, chromium, and combinations thereof.

6. The system of claim 5, wherein the preform structure is formed from the same material as the metallic powder.

7. The system of claim 1, wherein the powder distribution device comprises a retractable conveyor belt.

8. The system of claim 1, wherein the powder distribution system comprises a biaxial gantry system.

9. The system of claim 1, wherein the at least one preform structure comprises a second preform surface.

10. The system of claim 9, wherein the second preform surface is a downward-facing surface, an internal surface, a threaded surface, and combinations thereof.

11. The system of claim 1, wherein the at least one preform structure comprises a first preform structure and a second preform structure.

12. A method of fabricating a hybrid component, the method comprising:
securing a preform structure proximate to a build platform;
depositing a first amount of a metallic powder onto a platform surface, the platform surface being located at a first elevation;
depositing a second amount of the metallic powder onto a preform surface, the preform surface being located at a second elevation; and
energizing the first and second amounts of the metallic powder to form a fused layer.

13. The method of claim 12 and further comprising: repeating the depositing and energizing steps to form the hybrid component, the hybrid component comprising the preform structure and a plurality of fused layers.

14. The method of claim 12, wherein the second elevation is greater than the first elevation.

15. The method of claim 14, wherein the first and second amounts of the metallic powder are deposited using a powder deposition device disposed above the build platform at a third elevation.

16. The method of claim 15, wherein the third elevation is greater than the second elevation.

17. The method of claim 15, wherein the powder deposition comprises a retractable conveyor belt or a biaxial gantry system.

18. The method of claim 12, wherein securing the preform structure comprises brazing or welding the preform structure to a surface of the build platform.

19. The method of claim 12, wherein securing the preform structure comprises brazing or welding the preform structure to a fused layer of the metallic powder.

20. The method of claim 12, wherein energizing the metallic powder is performed by a directed energy source, such as a laser or an electron beam.
